(19) United States
(12) Patent Application Publication
(10) Pub. No.: US 2003/0017442 A1
(43) Pub. Date: Jan. 23, 2003

(54) Standards-based adaptive educational measurement and assessment system and method

(76) Inventors: William P. Tudor, Poway, CA (US); Meredith L. Manning, San Diego, CA (US); John O'Hair, San Diego, CA (US)

Correspondence Address: THE MAXHAM FIRM, 750 "B" STREET, SUITE 3100, SAN DIEGO, CA, 92101, US

(21) Appl. No.: 10/174,085

(22) Filed: Jun. 17, 2002

Related U.S. Application Data
(60) Provisional application No. 60/298,466, filed on Jun. 15, 2001.

(51) Int. Cl. G09B 7/00

(52) U.S. Cl. 434/322

(57) ABSTRACT

An educational method and system that assess and enhances a student's understanding in a subject. Based on the student's grade or instructional level, individually tailored tests are generated whose difficulties are geared toward the student's level of understanding in the subject. The adaptive measurement application system uses a plurality of learning objectives for a number of different subjects coupled to specialized questions to accurately assess a student's academic ability. An expert system uses this database of learning objectives and questions to quickly determine a student's ability without forcing the student to have to answer large number of questions. The adaptive measurement application system also employs a curriculum alignment guide to accurately align and report the data in accordance with varying national, state, school district, or school standards.

### REFERENCE TO RELATED APPLICATION

The present application claims priority to U.S. provisional application No. 60/298,466, filed Jun. 15, 2001.

### BACKGROUND OF INVENTION

1. Field of Invention

The present invention relates to methods and systems for educational testing, evaluation and assessment. More particularly, the invention is directed to a system and method that adapts to and tests a individual's proficiency in a particular subject area, assessing the results and aligning the results with varying national, state or local standards.

2. Discussion of Related Art

Testing the understanding and proficiency of an individual or student in a specific subject area is believed to be important to the learning process. In most educational settings, students are first presented with information to be learned and then to measure what was learned, a test is given. Testing has evolved into a very specialized field. Many theories have been developed for tests to measure a particular level of achievement or mastery, as well as to interpret the results of such tests. As a result, standardized tests have been developed to measure such things as intelligence, fitness to practice a profession such as the law or medicine, aptitude for success in a specific environment, and mastery of individual skills, among others.

Historically, tests have been administered either individually, such as oral or written examinations, or in the typical educational group setting where students take the test and record their answers on paper that are evaluated at a later time. One of the advantages of a written test is the efficiency in testing a large number of individuals. Unfortunately, a written test administered in such a manner lacks the ability to provide immediate feedback on an individual basis. Therefore, it is unreasonable to expect that testing, in the traditional educational setting, can be developed in such a way to efficiently and immediately measure an individual student's knowledge and proficiency in a particular subject area.

Additionally, to minimize the probability of a student's test score being influenced by others, multiple tests have been developed and administered simultaneously so that each student is, in effect, taking a different test. The problems associated with this methodology relate to the effort and expense of developing, grading and reporting multiple test results. There are serious limits to this testing approach.

A great number of educators believe that the measurement of performance and feedback is critical to the learning process. While written tests may be an efficient way to measure performance, they are largely inefficient in providing adequate feedback for learning. This is due to the fact that there is a significant time lag between the times when a test is given and when the results of the test are returned. During this time, new information is usually presented by the instructor and learned by the student. When the tests are finally returned, the focus of both the material and the student has shifted. Thus, relatively few students use such a test to evaluate their weaknesses, which could enable them to return to prior material with the objective of strengthening those weaknesses. One approach used to overcome this limitation is to structure courses of study with several smaller tests interspersed throughout the material. While this generally improves the potential for feedback, it is still relatively inefficient.

Many educators also realize that the optimal form of instruction is to personalize the learning experience for each student. This, however, is impractical in most traditional educational environments. To provide a better setting that more closely approaches the ideal learning experience, many school districts, for example, have turned to computer-based educational systems. Some of these computer-based educational systems have been developed to provide course materials in a specific subject area, test and tally the score, as well as provide some immediate feedback as to proficiency and understanding of the student with regard to the material presented.

Most of these types of computer-based systems or programs are designed to first present a section of information, such as reading, math or one of the other sciences, after which the system tests the student based on the information presented. The structures of these programs are generally organized in a pre-set or pre-defined manner. In other words, they are not adaptive to the individual's proficiency. Systems that are organized to present information in this manner are very inflexible and therefore do not provide an assessment of a student's educational proficiency in a subject area.

In an attempt to remedy this shortcoming, some programs employ a global or overview test. These tests allow a student to be tested on the entire subject matter. Due to the general nature of these tests, a student must have a thorough knowledge of the specific subject material before these tests can be utilized. As a result, there still remains an inability to assess a student's ability or proficiency in a particular subject area and compare these results with prescribed educational standards.

Therefore, traditional computer-based educational systems that employ fixed-format exams, and presenting the same number of questions to each student, do not consider the proficiency or level of understanding of a student in a subject area. Rather, the measure of a student's performance or score from this type of test is usually dependent on the number of questions answered correctly. The more a student knows, the more questions he or she is able to answer correctly. This approach has had a long and generally successful history. However, it is clear that this traditional test methodology presents more questions than are necessary. For many students there are questions that are far too easy and those that are far too hard. Testing students on questions that are above or below their ability does not provide instructional information, but tends to frustrate the student. Moreover, an incomplete assessment of the student is provided, because all that is known is whether the student is deficient, average or superior. The exact amount of those characteristics are not provided.

More recently, computer-based educational systems have incorporated an adaptive form of testing a student's understanding and proficiency in a subject area. Adaptive testing is a test methodology that tailors itself to the ability of the test taker or student. Computer-based adaptive test systems initially present a question of moderate difficulty to a student. After the answer is given, the question is scored immediately. If correct, the system statistically evaluates the student's ability as being higher than previously estimated. The system then presents a question that matches that perceived higher ability. On the other hand, if the first question is answered incorrectly, the system will reduce the estimate of ability to a lower grade level. The system then presents a second question and waits for the answer. After the answer is given, the system scores the second question. If correct, the system re-estimates the student's ability as higher; if incorrect, the system re-estimates the ability as lower. The system will then search for a third question to match the new ability estimate. This process continues with the test gradually locating the student's competence level. The resultant score that serves as an estimate of competence gets more accurate as each question is given. The test ends when the accuracy of that estimate reaches a statistically acceptable level or when a maximum number of items have been presented.

Another approach is an adaptive test system that takes into account how each student answers randomly presented questions. A low-ability student and a high-ability student will see a different array of questions. The low-ability student will see mainly relatively easy questions, while the high-ability student will see more difficult questions. With this approach, both individuals may answer the same percentage of questions correctly, but because the high-ability student can answer more difficult questions correctly, he or she will get a higher score. Even though these testing systems use a statistical framework to evaluate a student's competence by the predictability of one or more scores, educators are only able to see how a student performed in relation to other students not in relation to any of the accepted or prescribed standards.

The testing methods mentioned above, have proved to be somewhat beneficial, but they either take too long for the results to be returned, assess student's out of their ability level, or provide one overall score that is not in relation to a set of standards. With the increased demands for improved education results, more and more state agencies are holding both district and school administrators, as well as teachers, accountable for a student's performance and proficiency against a set of standards in order to increase student achievement. In recent years, the demand for standards-based assessment has increased. More and more states are holding the districts, schools, teachers and students accountable to the standards. Therefore, there is a need for a standards-based assessment system that not only provides instructors with valuable information regarding each individual student in relation to a set of varying standards, but also provides that information timely and efficiently.

### SUMMARY OF THE INVENTION

The primary purpose of the invention, as embodied and described herein, relates to an educational method and system that adapts to and measures the proficiency of an individual in a specific subject area and assesses those abilities against a specific set of varying local, state or national standards. The present invention uses standards-based adaptive measurement assessment, which is an outgrowth of the Item Response Theory (IRT). IRT uses a large item bank of questions with difficulty indices. However, standards-based adaptive measurement assessment uses a system of branching based on expert modeling to assess every unit within an area, which thereby reduces the number of questions required to assess the individual. This is a procedure well known to those skilled in the art.

In accordance with the purpose of the invention, as described herein, the invention fulfills the need by providing a method of diagnostically assessing the performance and proficiency of a student by scaling or aligning the results for a plurality of tests with a set of standards, each test having at least one item and each item having at least one feature.

In further accordance with its purpose, the invention includes a curriculum alignment mechanism to align each student's results to an individualized set of standards. In a traditional school environment, these standards can be district, state or national, which of course are widely varying. An advantage of this system is the immediate correlation of the particular objectives met and not met with the local standards. Also immediate availability of results online allows educators to make appropriate data-driven decisions for each student or group.

In one embodiment of the invention, a test system for standards-based measurement of an individual's knowledge and proficiency is provided. It has an item bank made up of a plurality of questions, where each question is associated with a learning objective and each learning objective has an associated score. A set of standards are associated with the learning objectives and a modeling system is provided which controls which question from the item bank will be presented to the individual. An adaptive measurement system which presents a question to the individual and, depending on whether the answer is correct or incorrect, adjusts the difficulty of the subsequent questions either up or down until the difficulty of the questions are representative of the individual's knowledge and proficiency. Finally, a curriculum alignment guide, which recognizes the score for each question and adjusts the score so that when a report is generated, the individual's knowledge and proficiency are aligned to the standards associated with the learning objectives.

In a separate embodiment, the invention includes an item bank for use in a system for standards-based adaptive assessment. The item bank has a plurality of learning objectives ranging from grades two to twelve. The learning objectives are derived from district, state and national standards, and high-stakes tests.

The invention also provides a method for standards-based adaptive assessment using an item bank containing a plurality of learning objectives, where each learning objective is related to a specific standard and represented by a specific question. The test taker enters into the test at their assigned instructional level. It begins with one or two units of material to determine the starting instructional level of the test taker. A learning objective is presented to the test taker in the form of a question designed to test knowledge of that learning objective. The test taker is allowed to respond, and if the response is correct, a more difficult learning objective, in the form of a question, is presented to the test taker and a virtual floor is created, which indicates that the test taker knows the material below that point, and if the response is incorrect, a less difficult learning objective, in the form of a question, is presented to the test taker and a virtual ceiling is created, which indicates that the test taker does not know the material above that point. The test taker is then moved through the test at their instructional level through branching, so that when the test taker's instructional level in the first unit is reached, subsequent units are presented. The test is stopped when the test taker's instructional level is determined by the system. A unit progression index is reported for each unit. The unit progression index is correlated with the relevant standards and the results are displayed in the form of a report.

Advantages of the invention will be set forth, in part, in the description that follows and, in part, will be understood by those skilled in the art from the description herein. The advantages of the invention will be realized and attained by means of the elements and combinations particularly pointed out in the appended claims and equivalents.

### BRIEF DESCRIPTION OF THE DRAWING

The objects, features and advantages of the invention will be more clearly perceived from the following detailed description, when read in conjunction with the accompanying drawing, wherein:

FIG. 1a is a flowchart generally illustrating the steps performed by the adaptive measurement system to assess a student's understanding and proficiency in reading at particular instructional level in accordance with the invention;

FIGS. 1b comprises a flowchart illustrating the reading related assessment steps of FIG. 1a in greater detail;

FIG. 2 is a block diagram of a computer system used to perform the functions of a described embodiment of the invention;

FIG. 3a is a flowchart that generally illustrates the steps performed by the adaptive measurement system through branching to assess a student's understanding and proficiency in a particular subject for particular instructional level in accordance with the invention; and

### DETAILED DESCRIPTION OF THE PREFERRED EMBODIMENTS

The present invention now will be described more fully with reference to the accompanying drawing, in which the preferred embodiments of the invention are shown. The present invention may, however, embodied in many different forms and should not be construed as limited to the embodiments set forth herein. Rather these embodiments are provided so that this disclosure will be thorough and complete and will fully convey the invention to those skilled in the art.

Although the disclosure herein may refer to a student in an educational setting, the invention is not so limited. It is contemplated herein that the invention relates to any situation where an evaluation of knowledge or performance is required. For example, applicants for employment may be given a screening test using the present invention. Alternatively, professions where rigorous examinations are conducted would be suitable for the testing and assessment system described herein. This could relate to, for example, physicians, lawyers, accountants, pilots and others who are in such a position of responsibility that their competence and detailed knowledge must be evaluated and determined to meet minimum standards. Therefore the invention has applicability, for example, for any position requiring a professional license or test where the stakes are high. The present invention could also have military applications as well, for example, where members are trained on specific subjects and then testing is performed.

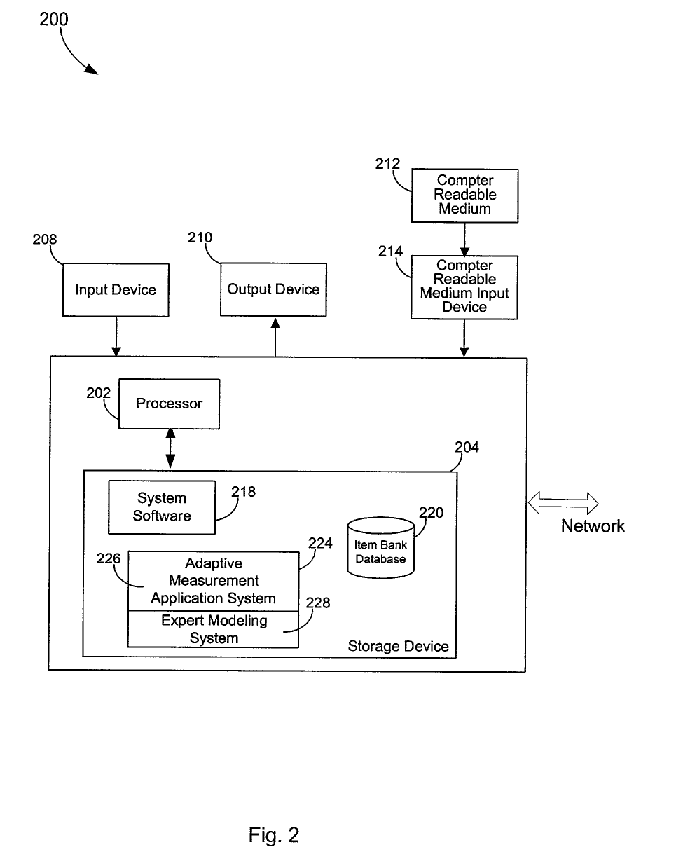

FIG. 2 shows a typical computer system 200 that may be employed that is programmed to perform the functions of a student workstation or system such as those used in an educational resource center. The system includes processor 202 and some form of storage device 204. A portion of the storage device may contain the software program, tools and data of the present invention. The storage device is capable of storing the system software 218 and application programs 224, and database or item bank 220 that contains a plurality of learning objectives. The item bank in the storage device contains a plurality of learning objectives and application programs containing executable computer instructions in accordance with the present invention. The storage device also includes other system software, such as application programs 224 that include adaptive measurement application system 226 and expert modeling system 228. The expert system accesses the database of learning objectives to measure a student's proficiency in a subject area as well as to compare and align this assessment with a plurality of national, state or local standards. The expert system accesses the database and determines the student's ability without having to answer a huge number of questions. The expert model selects a new learning objective depending on whether the previous learning objective was answered correctly or not. This method of selecting learning objectives to be tested is used until the student's instructional level for that particular unit is determined. The student is then given a progression index score for that unit. This process repeats until the student has been exposed to all units which are appropriate for their instructional level.

Alternatively, and more preferably, the computer used by the individual need only contain basic operating systems and conventional memory, as well as a suitable connection to the Internet. In a preferred embodiment, the present invention contemplates that all the software required to run the system are contained in a remote location, connected to the individual user by the remote means, such as the Internet. Accordingly, this is advantageous because it reduces material cost for the user, or provider, and it allows the test to be performed at any point in the world where a connection to the Internet is available. The discussion herein will relate to the remote location of the software and any associated hardware necessary.

In the following discussion, it is understood that the invention is not limited to any particular programming language or operating system. The instructions in storage device 204 are read into memory from computer-readable medium 212. Execution of sequences of instructions contained in the storage device causes the processor to perform the steps described herein. In alternative embodiments, hard-wired circuitry may be used in place of, or in combination with, software instructions to implement the invention. Thus, embodiments of the present invention are not limited to any specific combination of hardware circuitry and software.

The term “computer-readable medium” as used herein refers to any medium that participates in providing instructions to a processor for execution. Such a medium may take many forms including, but not limited to, non-volatile media, volatile media, and transmission media. Non-volatile media includes, for example, optical or magnetic disks, such as a storage device. Volatile media includes dynamic memory. Transmission media include coaxial cables, copper wire and fiber optics, including the wires that comprise a bus within a computer. Transmission media can also take the form of acoustic or light waves, such as those generated during radio wave and infrared data communications. Common forms of computer-readable media include a floppy disk, a flexible disk, a hard disk, magnetic tape, or any other magnetic medium, a CD-ROM, any other optical medium, punch cards, paper tapes, any other physical medium with patterns of holes, a RAM, a PROM, an EPROM, a FLASH-EPROM, any other memory chip or cartridge, a carrier wave as described hereafter, or any other medium from which a computer can read. The instructions can also be transmitted via a carrier wave in a network, such as a LAN, a WAN, or the Internet.

While the present invention will be described as a single system, a single server and a single educational resource or service environment, it will be appreciated by those skilled in the art the benefits and advantages of the invention are also applicable to a multi-user environment. For example, since all that is needed is a standard computer system and an appropriate Internet connection, multiple users at any one location may access the system described herein. For example, a full T1 line can support approximately 150 students testing simultaneously.

Item bank 220 is created from the correlation of both state objectives and assessment standards, and national objectives and assessment standards, as well as a plurality of critical skills taught throughout the country. By analyzing these standards and collating them with the learning objectives from a plurality of standardized tests, a common set of essential learning objectives and skills for each subject for all grade levels are generated to form the item bank. It is contemplated that in a preferred embodiment, this measurement and evaluation system will be used in grades two through twelve. However, the invention can also be used in other environments, for example, professional qualifying examinations, graduate school entrance examinations, medical school entrance examinations, and the like.

The adaptive measurement application system (AMAS) uses these essential learning objectives and an associated set of questions to accurately measure the understanding and/or proficiency of a student in a particular subject or unit, such as reading, mathematics or science and at a specified grade level. The learning objectives employed by the AMAS may be tested either singularly, such as by finding the main idea of a reading passage, or in a sequence of questions such as solving a number of problems, for example, multiplying fractions.

In addition, the learning objectives created from collating both state and national standards with those found on a number of standardized tests, found in the item bank or database, are able to assess a student's understanding and proficiency of a subject over a wider range of essential skills. In one embodiment the item bank may contain about one thousand learning objectives or questions. Here, a student's understanding and proficiency in a particular subject area can be measured from the second grade through twelfth grade, rather than from within a narrow range of two grade levels below to two grade levels above, which is found in most standardized testing systems. Students are assessed in accordance with their ability. More precisely, the AMAS is able to measure a student's performance or proficiency against a set of standards, rather than comparing student performance against the performance of other students. Therefore, a test administered by the present invention is referred to as a criterion referenced test.

Another advantage of the present invention is that the various report levels and formats that are available, for example, by student, course, class, school, district, county, state, course, staff, learning objectives, show what grade level the individual test taker is at for the particular unit. According to standard testing techniques, the results only show whether a student is deficient. The amount of that deficiency is not provided. Moreover, the present invention can also show how much a student is superior in a particular unit. This would be especially valuable in educator's decisions for advanced promotion of students.

Another feature of the present invention is that the opportunity for cheating is minimized. There are several forms of the item bank, which means that each time a student takes the test, there is a good probability that the questions will be different. Even if two students, adjacent to one another, see the same question on the screen, the answers are scrambled.

The present invention also comprises a special element that can be used to identify the student's individual style of learning. This can be especially helpful in selecting an appropriate teaching style for an individual student.

Examples of learning objectives in math include the ability, for example: to identify the value of a group of coins; to subtract decimals that do not require regrouping; to divide a decimal number by a whole number; to write numbers given in scientific notation in standard form; to be able to complete a number pattern; to divide one to two digit numbers by one digit numbers with no remainder. There are many more learning objectives that have been identified by district, state and local standards. It is contemplated herein, and understood by those skilled in the art that the number and kind learning objectives are dependent upon the particular subject matter being examined. For example, it would be reasonable to expect that math has a different range of learning objectives than a test for medical school admission. The number of learning objectives, is theoretically unlimited.

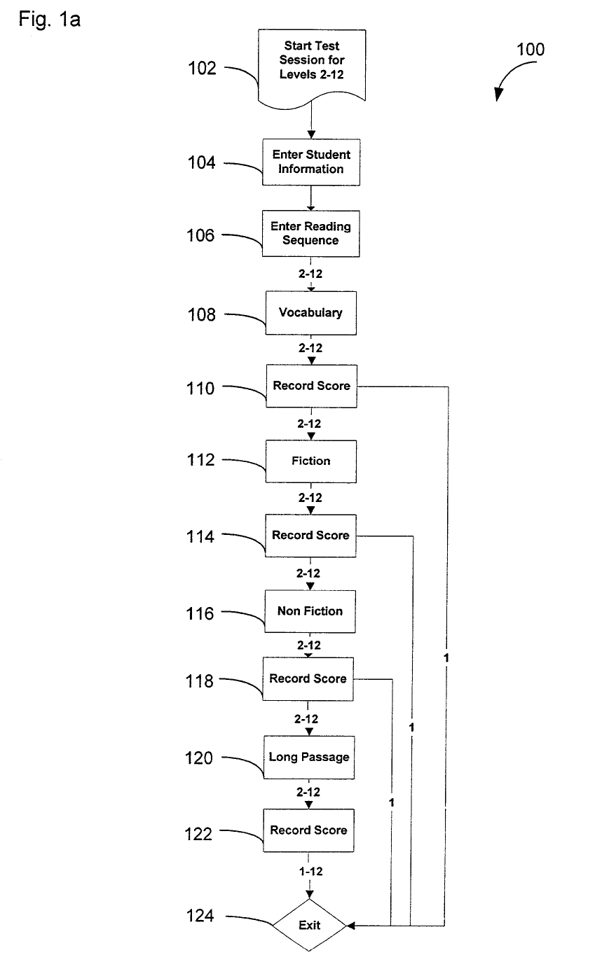

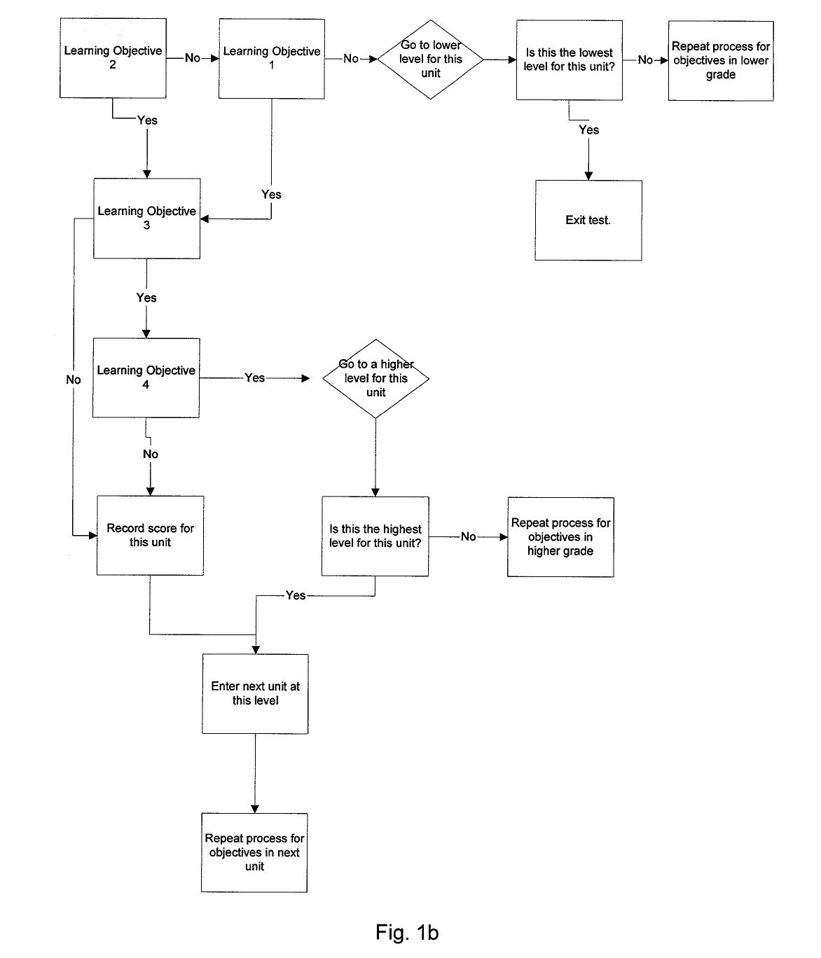

Referring now to FIGS. 1a and 1b, flowcharts illustrate the steps performed by the adaptive measurement application system to assess a student's understanding and proficiency in reading at particular instructional level. FIG. 1b shows in more detail a typical flow of events employed by the expert system of the AMAS to access and use the item bank. Here, a majority of the numerous reading skills found in the item bank which are used by the AMAS to measure a student's instructional level can be found in a number of state and or national educational standards.

By using the learning objects, content and essential skills stored in the item bank, the expert system is able to streamline the process of quantitatively determining the instructional level of a student in a particular subject area. Even though the AMAS is able to access the content, learning objects and essential skills found in the item bank to formulate a sequence of questions for a subject, a student is not required to take such an extensive or complicated test. As shown in system 100 in FIG. 1a, the test is started at step 102. At step 104, the student enters his or her current grade level. To start the testing process, the expert system, at steps 106 and 108, retrieves and presents an array of vocabulary words that can be recognized and defined by a student at that grade level. If an acceptable number of words are not recognized or defined, the expert system selects and tests a new set of words at a lower grade level. This process is repeated until either the appropriate level has been found or the lowest grade level that can be tested has been reached. If an acceptable number of words are recognized, the expert system, at step 110 records a score. At step 112, an appropriate fictional passage is selected at that grade level from the item bank. The passage and associated question sequence are then presented to test the student's understanding of the passage. At step 114, a score is recorded for this unit. The test system repeats this process for each unit (steps 108, 112, 116 and 120), and the test system is exited at step 124.

FIG. 1b shows the path the AMAS and expert modeling system go through for a reading unit, as specified in FIG. 1a. If learning objective 2 is not met, by an incorrect answer to a related question, then the system goes to learning objective 1. If this is still answered incorrectly, the system goes to a lower level for this reading unit. If this is the lowest level for this unit then the test exits and a score is reported. If it is not the lowest level for this unit, then the next lower level is chosen and the test is repeated. If however, learning objective 2 is met, by a correct answer, then the system presents a question appropriate for learning objective 3. If this is not answered correctly, then a score is recorded for this unit and the next unit is entered at this level. However, if the answer under learning objective 3 is answered correctly, then a question appropriate to learning objective 4 is presented. If this is answered incorrectly, the score is recorded and the next unit is entered at this level. If the answer for learning objective 4 is correct, then the system goes to a higher level for this unit. If this is the highest level for this unit the test enters the next unit at this level. If this is not the highest unit, then the process is repeated for objectives in the next higher grade.

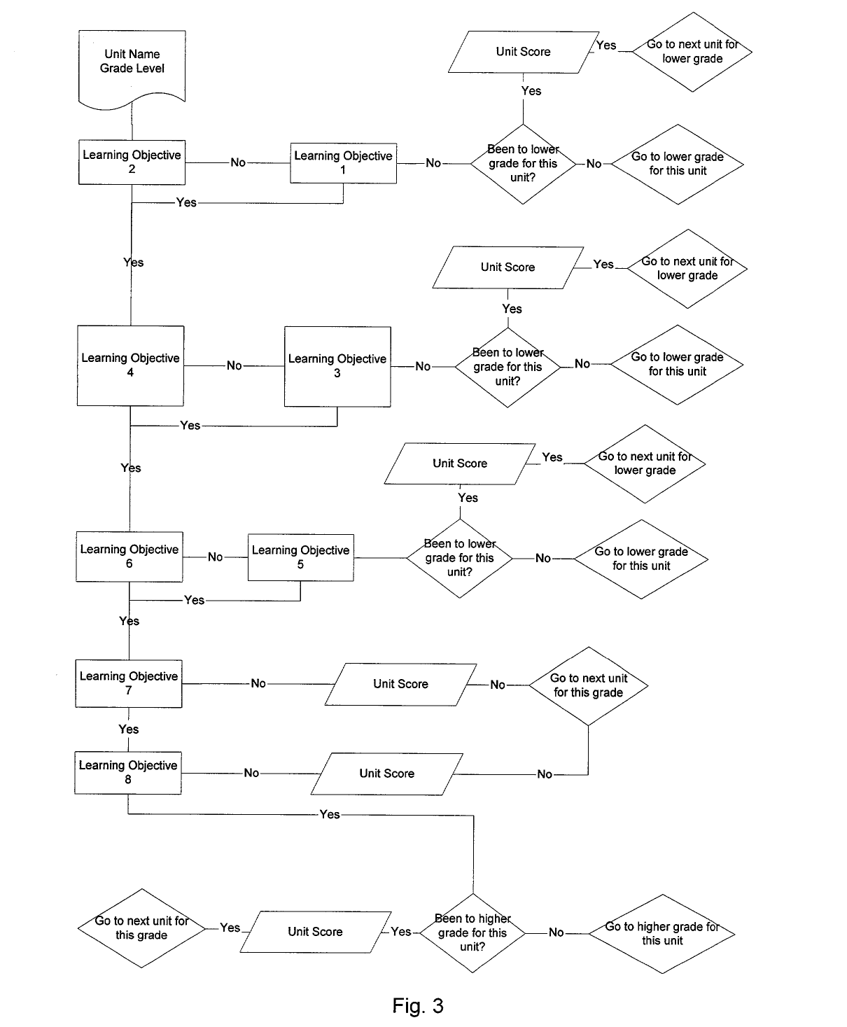

As shown in FIG. 3, the standards-based adaptive measurement uses a system of branching based on expert modeling. The expert modeling places a flowchart on top of the item bank of learning objectives to trim the test down to the student's instructional level. Although the test encompasses grade levels two through twelve, the individual student does not have to take the entire test. Instead, the expert system will narrow in on the student's instructional level and test the student there. Assessments using a controlled number of items typically have four to five samples for each objective. In order to show performance below and above expectations, a standardized test will include items from two grade levels below and two grade levels above. These items provide the floor (the lowest reportable performance) and the ceiling (highest reportable performance) for all students taking the test. If a student takes, for example, the fifth grade test, he or she will typically see a few items that are expected to be mastered at the third grade and a few items that are expected to be mastered at the seventh grade. The assessment will not, however, provide performance information specific to those working at the second grade level or those performing at the eighth grade level like the standards-based adaptive measurement does. In order to provide enough items to identify grade level performance of all students using the traditional model, the test would be hours long. There is no adaptability of flexibility for reducing the number of items tested to allow these students to show their individual performance. They must answer all simple questions, even if they have answered more difficult questions indicating mastery of more complex concepts.

The standards-based adaptive measurement adjusts the test items based on the student's ability level. There is no out-of-level testing and each student receives a unique test for their ability level. The branching system in the standards-based adaptive measurement allows students to move through the test based on their instructional level. The criterion established within the branching system remains the same, but each student may follow a different path. This allows for accurate measurement of student gains because the basis of the test is the same no matter which point of entry (grade level) is sued or which path the student followed.

The student enters the test at their assigned grade level into one of the placement units. These units give an estimate of where the student is performing. All of the units within the assessment are computer-adaptive so if the student is strong in one unit and weak in another, it will show up in the results.

The student is given a question that is linked to a learning objective. The subsequent learning objectives that the student receives are dependent on the answers to the previous questions. If the previous question is answered correctly, then the difficulty of the next learning objective is decreased. Each time a question is answered incorrectly, an imaginary ceiling is created, which indicates that the student does not know the material above that point. Each time a question is answered correctly, an imaginary floor is created, which indicates that the student knows the material below that point. This is detailed in the flowchart shown in FIG. 3. A system of guess checks is also implemented to ensure that the assumptions are accurate. The student will continue to move through the assessment until the instructional level is determined. This stopping point is determined by having the ceiling and the floor narrow in on the point at which the student is at their instructional level. Once the student reaches this point, a unit progression index will be reported.

The student will continue to move through a series of units and will exit each unit once the instructional level is determined. The number of learning objectives that a student receives varies from student to student. The length of time to take the test varies to a degree on the disparity between the grade in which the student is enrolled and their true individual performance. For example, a student that is enrolled in the fourth grade and performing at the fourth grade level will typically finish in the least amount of time. A student that is currently enrolled in the fourth grade, but performing at a second grade level will take longer, as the test will begin at the fourth grade but when the student is unable to perform at that level, it will eventually drop to the second grade level. Similarly, a student that is enrolled in the fourth grade but performing at the seventh grade level will receive more questions that a student who is performing at their assigned grade level. This is because they will be assessed until the system locates their correct instructional level. In this embodiment there is no preset time limit in the tests, so the student is able to take as long as they need to finish the test. However, in alternative embodiments, time limits may be employed.

In addition to the expert modeling system, other embodiments of the present invention have the capability to be individualized to specific standards by implementing the curriculum alignment guide. The customized curriculum alignment guide is a way to align the item bank of learning objectives to the individual national, state, school district or school standards. Each learning objective is assigned an adjusted grade equivalency, which corresponds to the grade level in the standards. The test and branching system, however, do not change. The only aspect of the product that is altered is the report feature. The reports generated from the test will reflect the adjusted grade levels of the standards used. If the student has previously tested, the reports will show their gains. The standards-based adaptive measurement has the ability to measure growth on a consistent scale. The alignment guide will be discussed in further detail below.

The system operates by assigning each learning objective a difficulty level. When the test is completed, the curriculum alignment mechanism then aligns the individual score to accord with the governing local or state standard according to the particular learning objective. For example, one state's standards may require that in grade three the student must be able to place a series of decimal numbers in order from least to greatest, or from greatest to least. However, in another state, this objective may be classified at a grade four level. Therefore, the curriculum alignment guide would change the individual's score, or progression index (PI index), to place that student at a grade level that accords with the state's standard. It is important to note that the curriculum alignment guide does not change the answer to the question, but rather only changes the score given.

The reports produced by the present invention are set up in a hierarchical manner allowing access at different levels. These levels range from data-entry to the state level, so that security is maintained while accessing scores. Therefore, a superintendent, for example, will be able to view reports for all of the schools in the district, while a teacher will only be able to access reports for their own class. Another feature of the reports may be that they are able to display student results according to demographical groups.

The invention has been illustrated and described by means of specific embodiments. It is to be understood that numerous changes and modifications may be made therein without departing from the scope of the invention as defined in the appended claims.

What is claimed is:

1. A test system for standards-based measurement of an individual's knowledge and proficiency comprising:
an item bank comprised of a plurality of questions, each question associated with a learning objective and each learning objective having an associated score;
a set of standards associated with the learning objectives;
an expert modeling system which controls which question from the item bank will be presented to the individual;
an adaptive measurement system which presents a question to the individual and, depending on whether the answer is correct or incorrect, adjusts the difficulty of the subsequent questions either up or down until the difficulty of the questions are representative of the individual's knowledge and proficiency; and
a curriculum alignment guide which recognizes the score for each question and adjusts the score so that when a report is generated, the individual's knowledge and proficiency are aligned to the standards associated with the learning objectives.

2. The system of claim 1, wherein the item bank contains over one thousand items.

3. The system of claim 1, wherein the individual is selected from the group consisting of a student between grades two and twelve, a university student, and an applicant for a professional license or degree.

4. The system of claim 1, wherein the standards are selected from the group consisting of school, district, county, state and national standards.

5. The system of claim 1, wherein the test system is accessed over the Internet.

6. The system of claim 5, wherein reports are generated from the scores immediately at the conclusion of the test so that data-driven decisions can be made immediately.

7. An item bank for use in a system for standards-based adaptive assessment, said item bank comprising:
a plurality of learning objectives ranging from grades two to twelve, wherein said learning objectives are derived from district, state and national standards and high-stakes tests.

8. The item bank of claim 7, wherein said plurality of learning objectives are about one thousand in number.

9. The item bank of claim 8, wherein the plurality of learning objectives are related to a plurality of disciplines or subjects with specialized questions for each discipline or subject to accurately diagnose the individual's knowledge and proficiency.

10. A method for standards-based adaptive assessment comprising:
using an item bank containing a plurality of learning objectives, each learning objective being related to a specific standard and represented by a specific question;
entering the test taker into the test at their assigned instructional level;
beginning with one or two units of material to determine the starting instructional level of the test taker;
presenting a learning objective to the test taker in the form of a question designed to test knowledge of that learning objective;
allowing the test taker to respond, wherein if the response is correct, a more difficult learning objective, in the form of a question, is presented to the test taker and a virtual floor is created, which indicates that the test taker knows the material below that point, and wherein if the response is incorrect, a less difficult learning objective, in the form of a question, is presented to the test taker and a virtual ceiling is created, which indicates that the test taker does not know the material above that point;
moving the test taker through the test at their instructional level through branching,
wherein when the test taker's instructional level in the first unit is reached, subsequent units are presented;
stopping the test when the test taker's instructional level is determined by the system;
reporting a unit progression index for each unit;
correlating the unit progression index with the relevant standards; and
displaying the results in the form of a report.

11. The method of claim 10, wherein said method is employed from a location remote to the item bank.

12. The method of claim 11, wherein the Internet is used.

13. The method of claim 10, wherein the item bank contains over one thousand items.

14. The method of claim 10, wherein the standards are selected from the group consisting of school, district, county, state and national standards.

15. The method of claim 10, wherein the reports are generated from the scores immediately at the conclusion of the test so that data-driven decisions can be made immediately.
